(19) United States
(12) Patent Application Publication
(10) Pub. No.: US 2024/0340676 A1
(43) Pub. Date: Oct. 10, 2024

(54) METHOD AND SYSTEM FOR CONFIGURING MEASUREMENT GAPS IN WIRELESS NETWORK

(71) Applicant: Samsung Electronics Co., Ltd., Suwon-si (KR)

(72) Inventors: Aby Kanneath ABRAHAM, Bangalore (IN); Seungri JIN, Suwon-si (KR); Sriganesh RAJENDRAN, Bangalore (IN); Vinay Kumar SHRIVASTAVA, Bangalore (IN)

(21) Appl. No.: 18/624,893

(22) Filed: Apr. 2, 2024

(30) Foreign Application Priority Data
Apr. 4, 2023 (IN) 202341025562
Mar. 27, 2024 (IN) 202341025562

(51) Int. Cl. H04W 24/10

(52) U.S. Cl. CPC H04W 24/10

(57) ABSTRACT

Disclosed herein is a method for configuring one or more measurement gaps in a wireless network. The method includes receiving a configuration message with one or more network parameters from a network device. The one or more network parameters include an LTM candidate cell configuration, a measurement gap configuration MG configuration includes a candidate identifier or NR-ARFCN or RS configuration of LTM measurements associated with MG, a type-1 measurement gap configuration, received CellGroupConfig from a distributed unit (DU). The method includes performing one or more actions upon receiving the configuration message. The one or more actions include creating an LTM candidate configuration, associating the measurement gap to an LTM measurement configuration, and applying the received measurement gap for both LTM and L3 measurements. The method includes sending an RRC reconfiguration complete message to the network device upon the completion of the one or more actions.

### CROSS-REFERENCE TO RELATED APPLICATIONS

This application is based on and claims priority under 35 U.S.C. § 119 to Indian Patent Application No. 202341025562 filed on Apr. 4, 2023, and Indian Patent Application No. 202341025562 filed on Mar. 27, 2024, both filed in the Indian Intellectual Property Office, the disclosures of which are incorporated by reference herein in their entirety.

### BACKGROUND

### 1. Field

The present disclosure generally relates to the field of wireless communication networks, and more specifically relates to a method and a system for configuring one or more measurement gaps in a wireless network.

### 2. Description of Related Art

In wireless communication networks such as long-term evolution (LTE) and 5G new radio (NR), measurement gaps refer to specific time intervals during which a user equipment (UE) performs measurements on neighboring cells or frequencies associated with, for example, evolved NodeB (eNB), next-generation NodeB (gNB), etc. The measurement gaps allow the UE to gather information about a radio environment, such as signal strength, interference levels, and quality of neighboring cells. This information is crucial for handover decisions, interference management, load balancing, mobility management, and optimizing network performance of the wireless communication network based on various 3rd Generation Partnership Project (3GPP) standards, as discussed throughout the disclosure.

In the 5G NR, consider a scenario where a movement of the UE across different cells involves the mobility management. In a radio resource control (RRC)_IDLE mode, this mobility management is achieved through a process known as cell reselection. Up to NR Release 17 of the 3GPP, mobility management was carried out using a procedure called as handover in an RRC_CONNECTED mode. Network-controlled mobility is applicable to UEs operating in an RRC_CONNECTED mode, requiring explicit RRC signaling triggered by the gNB in the NR. Additionally, the handover in the NR typically comprises three distinct stages such as handover preparation, handover execution, and handover completion. The gNB has a capability to instruct the UE to report measurements. Based on these measurements or the gNB's understanding of a network topology, the gNB may transmit an RRC reconfiguration message (such as NR RRCReconfiguration message) to initiate the handover of the UE from a source cell to a target cell. Subsequently, the UE accesses the target cell and sends an RRC reconfiguration complete message.

Additionally, NR release 16 of the 3GPP has introduced an alternative UE configuration method, where the gNB may configure the UE's execution conditions for initiating the handover. Upon meeting these conditions, the UE can transition to the target cell and confirm completion via the RRC reconfiguration complete message. Moreover, NR release 16 of the 3GPP has brought in a novel handover approach known as dual active protocol stack (DAPS) handover. In all the aforementioned techniques, the UE executes handovers by transmitting layer 3 (RRC) messages, leading to significant signaling overhead and latency challenges. This type of handover, along with conditional handover (CHO), is commonly referred to as layer 3 mobility.

In scenarios involving dual connectivity, the UE can execute primary cell change (PSCellChange) or conditional PSCellChange. Within the dual connectivity framework, PSCellChange or conditional PSCellChange falls under the umbrella of layer 3 mobility. For instance, handover, CHO, PSCellChange, conditional PSCellChange, etc., are collectively termed as layer 3 mobility. Moreover, the PSCellChange or conditional PSCellChange can also be denoted as secondary cell group (SCG) layer 3 mobility. Similarly, in dual connectivity contexts, handover and CHO can be categorized as master cell group (MCG) layer 3 mobility. The UE can engage in layer 3 mobility in response to receiving the RRC reconfiguration message instructing a handover process or upon executing conditional reconfigurations (CHO, conditional PSCell addition (CPA), or CPC). Furthermore, the UE may receive RRC configuration updates for modifying certain security parameters.

In release 18 of the 3GPP, there has been a focus on introducing lower layers (L1/L2 layers) triggered mobility management, referred to as lower layer triggered mobility (LTM), aimed at addressing issues such as latency, signaling overhead, and other challenges associated with layer 3 mobility. The primary objective of the LTM is to facilitate a serving cell (e.g., source cell) change through L1/L2 signaling, with the aim of reducing latency, overhead, and interruption time. The network (e.g., gNB) is capable of configuring the UE with multiple candidate cells to expedite the application of configurations for these cells. Additionally, the network can utilize MAC control element (MAC CE) or L1 signaling to dynamically transition the UE from the source cell to one of the pre-configured candidate cells. Moreover, the LTM activation can be triggered based on L1 measurements rather than relying on L3 measurements for improved efficiency and performance.

Further, the 3GPP also provides one or more mechanisms for executing the LTM without resetting lower layers such as medium access control (MAC) to prevent data loss and minimize the additional delay in data recovery whenever feasible. For instance, the gNB has a capability to offer LTMCandidateConfiguration, which involves configuring one or more LTM candidate cells either through the RRC reconfiguration message for a candidate target cell, CellGroupConfig for each candidate target cell, or through any similar RRC structure or information element (IE) containing relevant fields. For instance, a new IE like LTM-CandidateConfig could be defined as an ASN.1 sequence comprising CellGroupConfig and other pertinent information elements in the RRC reconfiguration. Additionally, the gNB may further adjust or release the candidate configurations as needed. Even after transitioning to a candidate cell through the LTM, the UE can retain an LTM configuration of other candidate cells. Furthermore, the gNB may furnish the UE with a setup for conducting LTM measurements on various candidate frequencies and cells, enabling reporting based on these LTM measurements, an example sequence is given in Table-1 below.

| | |
|---|---|
| measObjectToRemoveList MeasObjectToRemoveList | OPTIONAL, |

-- Need N

| | |
|---|---|
| measObjectToAddModList MeasObjectToAddModList | OPTIONAL, |

-- Need N

| | |
|---|---|
| reportConfigToRemoveList ReportConfigToRemoveList | OPTIONAL, |

-- Need N
reportConfigToAddModList ReportConfigToAddModList
OPTIONAL, -- Need N

| | |
|---|---|
| measIdToRemoveList MeasIdToRemoveList | OPTIONAL, -- Need |

N

| | |
|---|---|
| measIdToAddModList MeasIdToAddModList | OPTIONAL, -- |

Need N
s-MeasureConfig CHOICE {
ssb-RSRP RSRP-Range,
csi-RSRP RSRP-Range

| | |
|---|---|
| } | OPTIONAL, -- Need M |

| | |
|---|---|
| quantityConfig QuantityConfig | OPTIONAL, -- Need M |
| measGapConfig MeasGapConfig | OPTIONAL, -- Need M |
| measGapSharingConfig MeasGapSharingConfig | OPTIONAL, -- |

Need M
...,
[[
interFrequencyConfig-NoGap-r16 ENUMERATED {true}
OPTIONAL -- Need R
]]
}

In NR release 17 of the 3GPP, the UE can receive configuration settings through the MeasConfig information element (IE) to conduct layer 3 measurements. The 3GPP NR specification outlines the definition of MeasConfig as detailed herein. Comprehensive information and definitions for all parameters related to MeasConfig can be found in 3GPP TS 38.331. For LTM measurements, the gNB can configure the UE with distinct measurement setups for both layer 3 mobility (utilizing MeasConfig IE in NR release 17) and LTM. The UE, which has been set up with measurement configurations for layer 3 mobility (measurements configured/performed/reported for layer 3 mobility, e.g., configured via R17 MeasConfig IE, is henceforth referred to as L3 measurements) and LTM (measurements configured/performed/reported for LTM are henceforth referred to as LTM measurements), conducts both L3 measurements and LTM measurements.

Further, there are multiple ways by which L1 measurements for the LTM may be provided to the UE. For example, the 3GPP is considering three different ways for providing L1 measurements to the UE as below:
a. Configurations for L1 measurement RS are provided under ServingCellConfig for the serving cells;
b. Configurations for L1 measurement RS are provided under CellGroupConfig for the candidate cells; and
c. Configurations for L1 measurement RS are provided separately from ServingCellConfig for the serving cells and CellGroupConfig for the candidate cells.

Furthermore, an L1 measurement report for the LTM is reported as a periodic report on a physical uplink control channel (PUCCH), a semi-persistent report on PUCCH/physical uplink shared channel (PUSCH), and an aperiodic report on the PUSCH. The L1 measurements may be reported using MAC CE. These reports may be scheduled by the gNB or initiated by the UE. In one option, the gNB may decide for the LTM through uplink (UL) measurements.

For a cell switch command, the gNB instructs the UE to perform the LTM, i.e., to move to the target candidate cell through downlink (DL) MAC CE or through L1 signaling. MAC CE triggering of the cell switch carries LTM-related information for the cell switch including the cell identifier. The procedure of triggering a change of cells via the LTM feature is called a cell switch. Both random access channel (RACH)-based (non-contention or contention free random access (CFRA), contention based random access (CBRA)) and RACH-less procedures for cell switches are supported. RACH-less cell switch may be used if the UE does not need to acquire TA during the cell switch. RACH resource for CFRA for cell switch may be provided in RRC configuration to the UE.

The LTM cell switch is supervised by a timer. The UE arrival in the target cell may be indicated to the network by UL signaling, either MAC signaling or RRC signaling. The timer which may be referred to as a “Tcellswitch” is started when the UE receives the cell switch command and is stopped once the cell switch is completed. In one option, the Tcellswitch is defined as a new timer. In another option, the existing NR RRC R17 timer T304 may be used for supervising the LTM cell switch, and the Tcellswitch in this disclosure is applicable for the timer T304 when the Tcellswitch is used for the LTM, such as supervising the LTM cell switch. The cell switch is completed once the UE successfully completes random access for the RACH-based cell switch. For RACH less cell switch, the cell switch may be completed once a UL transmission is successful (e.g., the UL transmission for indicating the in the target cell).

In NR release 18 of the 3GPP, the LTM is also supported in dual connectivity i.e., new radio dual connectivity (NR-DC). The gNB provides reference configuration, L1 measurement configuration, and candidate cell configuration in an RRC ASN.1 SEQUENCE used for the LTM configuration. An example sequence is given in Table-2 below:

```
TABLE 2
ASN1START
-- TAG-RRCRECONFIGURATION-START
RRCReconfiguration ::= SEQUENCE {
  rrc-TransactionIdentifier RRC-TransactionIdentifier,
  criticalExtensions CHOICE {
    rrcReconfiguration RRCReconfiguration-Ies,
    criticalExtensionsFuture SEQUENCE { }
  }
}
RRCReconfiguration-Ies ::= SEQUENCE {
```

| | |
|---|---|
| radioBearerConfig RadioBearerConfig | OPTIONAL, -- Need M |

secondaryCellGroup OCTET STRING (CONTAINING CellGroupConfig)
OPTIONAL, -- Cond SCG

| | |
|---|---|
| measConfig MeasConfig | OPTIONAL, -- Need M |

| | |
|---|---|
| lateNonCriticalExtension OCTET STRING | OPTIONAL, |
| nonCriticalExtension RRCReconfiguration-v1530-Ies | OPTIONAL |

}
RRCReconfiguration-v1530-Ies ::= SEQUENCE {
masterCellGroup OCTET STRING (CONTAINING CellGroupConfig)
OPTIONAL, -- Need M

| | |
|---|---|
| fullConfig ENUMERATED {true} | OPTIONAL, -- Cond |

FullConfig
dedicatedNAS-MessageList SEQUENCE (SIZE(1..maxDRB)) OF DedicatedNAS-
Message OPTIONAL, -- Cond nonHO

| | |
|---|---|
| masterKeyUpdate MasterKeyUpdate | OPTIONAL, -- Cond |

```
MasterKeyChange
  dedicatedSIB1-Delivery OCTET STRING (CONTAINING SIB1)
OPTIONAL, -- Need N
  dedicatedSystemInformationDelivery OCTET STRING (CONTAINING
SystemInformation) OPTIONAL, -- Need N
```

| | |
|---|---|
| otherConfig OtherConfig | OPTIONAL, -- Need M |

| | |
|---|---|
| nonCriticalExtension RRCReconfiguration-v1540-Ies | OPTIONAL |

}
RRCReconfiguration-v1540-Ies ::= SEQUENCE {

| | |
|---|---|
| otherConfig-v1540 OtherConfig-v1540 | OPTIONAL, -- Need M |

| | |
|---|---|
| nonCriticalExtension RRCReconfiguration-v1560-Ies | OPTIONAL |

```
}
RRCReconfiguration-v1560-Ies ::= SEQUENCE {
  mrdc-SecondaryCellGroupConfig SetupRelease { MRDC-SecondaryCellGroupConfig
} OPTIONAL, -- Need M
  radioBearerConfig2 OCTET STRING (CONTAINING RadioBearerConfig)
OPTIONAL, -- Need M
```

| | |
|---|---|
| sk-Counter SK-Counter | OPTIONAL, -- Need N |

| | |
|---|---|
| nonCriticalExtension RRCReconfiguration-v1610-Ies | OPTIONAL |

}
RRCReconfiguration-v1610-Ies ::= SEQUENCE {

| | |
|---|---|
| otherConfig-v1610 OtherConfig-v1610 | OPTIONAL, -- Need M |

| | |
|---|---|
| bap-Config-r16 SetupRelease { BAP-Config-r16 } | OPTIONAL, -- |

```
Need M
  iab-IP-AddressConfigurationList-r16 IAB-IP-AddressConfigurationList-r16
OPTIONAL, -- Need M
  conditionalReconfiguration-r16 ConditionalReconfiguration-r16
OPTIONAL, -- Need M
```

| | |
|---|---|
| daps-SourceRelease-r16 ENUMERATED{true} | OPTIONAL, -- |

Need N

| | |
|---|---|
| t316-r16 SetupRelease {T316-r16} , | OPTIONAL -- Need M |

```
  needForGapsConfigNR-r16 SetupRelease {NeedForGapsConfigNR-r16}
OPTIONAL, -- Need M
  onDemandSIB-Request-r16 SetupRelease { OnDemandSIB-Request-r16 }
OPTIONAL, -- Need M
  dedicatedPosSysInfoDelivery-r16 OCTET STRING (CONTAINING
PosSystemInformation-r16-Ies) OPTIONAL, -- Need N
  sl-ConfigDedicatedNR-r16 SetupRelease {SL-ConfigDedicatedNR-r16}
OPTIONAL, -- Need M
  sl-ConfigDedicatedEUTRA-Info-r16 SetupRelease {SL-ConfigDedicatedEUTRA-Info-
r16} OPTIONAL, -- Need M
```

| | |
|---|---|
| targetCellSMTC-SCG-r16 SSB-MTC | OPTIONAL, -- Need S |

| | |
|---|---|
| nonCriticalExtension RRCReconfiguration-v1700-Ies | OPTIONAL |

}
RRCReconfiguration-v1700-Ies ::= SEQUENCE {

| | |
|---|---|
| otherConfig-v1700 OtherConfig-v1700 | OPTIONAL, -- Need M |

```
  sl-L2RelayUE-Config-r17 SetupRelease { SL-L2RelayUE-Config-r17 }
OPTIONAL, -- Need M
  sl-L2RemoteUE-Config-r17 SetupRelease { SL-L2RemoteUE-Config-r17 }
OPTIONAL, -- Need M
  dedicatedPagingDelivery-r17 OCTET STRING (CONTAINING Paging)
OPTIONAL, -- Cond PagingRelay
  needForGapNCSG-ConfigNR-r17 SetupRelease {NeedForGapNCSG-ConfigNR-r17}
OPTIONAL, -- Need M
  needForGapNCSG-ConfigEUTRA-r17 SetupRelease {NeedForGapNCSG-
ConfigEUTRA-r17} OPTIONAL, -- Need M
  musim-GapConfig-r17 SetupRelease {MUSIM-GapConfig-r17}
OPTIONAL, -- Need M
  ul-GapFR2-Config-r17 SetupRelease { UL-GapFR2-Config-r17 }
OPTIONAL, -- Need M
```

| | |
|---|---|
| scg-State-r17 ENUMERATED { deactivated } | OPTIONAL, -- Need N |
| appLayerMeasConfig-r17 AppLayerMeasConfig-r17 | OPTIONAL, -- |

Need M
ue-TxTEG-RequestUL-TDOA-Config-r17 SetupRelease {UE-TxTEG-RequestUL-
TDOA-Config-r17} OPTIONAL, -- Need M

| | |
|---|---|
| nonCriticalExtension RRCReconfiguration-v18xy | OPTIONAL |

}
RRCReconfiguration-v18xy-Ies ::= SEQUENCE {
ltm-CandidateConfig-r18 SetupRelease {LTM-CandidateConfig-r18}
OPTIONAL, -- Need M

| | |
|---|---|
| nonCriticalExtension SEQUENCE { } | OPTIONAL |

}

For radio resource control information elements, the LTM-CandidateConfig. and the IE LTM-CandidateConfig are used to provide LTM candidate cell configuration. The LTM-CandidateConfig information element is given in Tables-3, 4, and 5 below:

```
TABLE 3
-- ASN1START
-- TAG-LTM-CANDIDATECONFIG-START
LTM-CandidateConfig-r18 ::= SEQUENCE {
  Lte-ReferenceConfiguration-r18 OCTET STRING (CONTAINING
RRCReconfiguration) OPTIONAL, -- Need N
ltm-CandidateToReleaseList-r18 LTM-CandidateToReleaseList-r18
OPTIONAL, -- Need N
  ltm-CandidateToAddModList-r18 LTM-CandidateToAddModList-r18
OPTIONAL, -- Need N
  ltm-candidatePartial-L2reset-Sets SEQUENCE (SIZE (1..FFS)) OF LTM-
CandidatePartial-L2reset-Set-18 OPTIONAL ...
}
LTM-CandidateToReleaseList-r18 ::= SEQUENCE (SIZE (1..maxNrofCellsLTM-
r18)) OF LTM-CandidateId-r18 OPTIONAL, -- Need N
LTM-CandidateToAddModList-r18 ::= SEQUENCE (SIZE (1..maxNrofCellsLTM-
r18)) OF LTM-Candidate-r18
LTM-CandidatePartial-L2reset-Set-18 ::= SEQUENCE (SIZE (1..FFS)) OF LTM-
CandidateId-r18
LTM-Candidate-r18 ::= SEQUENCE {
  ltm-CandidateId-r18 LTM-CandidateId-r18,
  ltm-Config-r18 OCTET STRING (CONTAINING RRCReconfiguration),
  ...
}
-- TAG-LTM-CANDIDATECONFIG-STOP
-- ASN1STOP
```

TABLE 4
ltm-CandidateConfig
Configuration of LTM candidate target SpCell(s), reference configuration, and sets of
cells in which full L2 reset is not applied in the LTM cell switch.

TABLE 5
LTM-CandidateConfig field descriptions
ltm-ReferenceConfiguration
This field includes an RRCReconfiguration message used to configure a reference
configuration for LTM.
ltm-Config
This field includes an RRCReconfiguration message used to configure an LTM candidate
cell. This field can include only the CellGroupConfig IE, RadioBearerConfig IE, and
MeasConfig IE.
ltm-candidatePartial-L2reset-Sets
This field indicates the sets of candidate cells in which full L2 reset is not performed
upon the LTM cell switch.

If the UE receives the RRC reconfiguration message including the LTM candidate configuration, the UE performs the LTM configuration. An example sequence for the LTM candidate configuration executed by the UE is given below (in the baseline CR for TS 38.331), Table-6.

TABLE 6
LTM configuration and execution

General

The UE shall perform the following actions based on a received LTM-CandidateConfig
IE:

1> if the LTM-CandidateConfig includes the ltm-ReferenceConfiguration:

2> perform the LTM reference configuration procedure as specified in 5.3.5.x.2;

1> if the LTM-CandidateConfig includes the ltm-CandidateToReleaseList:

2> perform the LTM candidate cell release as specified in 5.3.5.x.3;

1> if the LTM-CandidateConfig includes the ltm-candidatePartial-L2reset-Sets:

2> add the received ltm-candidatePartial-L2reset-Sets to VarLTM-Config;

2> if the LTM-CandidateConfig includes the ltm-CandidateToAddModList:

2> perform the LTM candidate cell addition or reconfiguration as specified in

5.3.5.x.4;

LTM reference configuration

The UE shall:

1> if ltm-ReferenceConfiguration is set to “setup”:

2> remove ltm-ReferenceConfiguration from VarLTM-Config, if stored;
2> store the received ltm-ReferenceConfiguration in VarLTM-Config;

1> else:

2> remove ltm-ReferenceConfiguration from VarLTM-Config;

LTM candidate cell release

The UE shall:

1> for each ltm-CandidateId in the ltm-CandidateToReleaseList:

2> if the current VarLTM-Config includes an ltm-Candidate with the given ltm-

CandidateId:
3> release the ltm-Candidate from VarLTM-Config;

LTM candidate cell addition/modification

The UE shall:

1> for each ltm-CandidateId in the ltm-CandidateToAddModList:

2> if the current VarLTM-Config includes an ltm-Candidate with the given ltm-

CandidateId:
3> modify the ltm-Candidate within VarLTM-Config in accordance with the

received ltm-Candidate;

2> else:

3> add the received ltm-Candidate to VarLTM-Config.

Generation of UE LTM configuration

The purpose of this procedure is to generate a UE configuration to be stored and applied
only when an indication of an LTM cell switch is received by lower layers.
The UE shall:

1> for each ltm-Candidate in ltm-CandidateConfigList within VarLTM-Config;

2> store the ltm-CandidateId included in ltm-Candidate within VarLTM-UE-

Config;

2> generate a UE configuration by applying the received ltm-Candidate included

within ltm-CellGroupConfigList to the referenceConfiguration (if any) and
store it in ue-LTM-Config within VarLTM-UE-Config.

LTM cell switch execution

Upon the indication by lower layers that an LTM cell switch procedure is triggered, the
UE shall:

1> apply the UE LTM configuration in UE-LTM-Config within VarLTM-UE-Config

```
  related to the LTM candidate cell configuration identity as received by lower
  layers.
```

For UE variables such as the VarLTM-Config, the IE VarLTM-Config is used to store the reference configuration and the LTM candidate cell configurations, as given in Table-7 below.

```
TABLE 7
VarLTM-Config UE variable
ASN1START
-- TAG-VARLTM-CONFIG-START
VarLTM-Config-r18-IEs ::= SEQUENCE {
  ltm-ReferenceConfiguration-r18 OCTET STRING (CONTAINING
RRCReconfiguration),
  ltm-CandidateList-r18 LTM-CandidateList-r18,
  ltm-candidatePartial-L2reset-Sets-18 SEQUENCE (SIZE (1..FFS)) OF LTM-
CandidatePartial-L2reset-Set-18
}
LTM-CandidateList-r18 ::= SEQUENCE (SIZE (1..maxNrofCellsLTM-r18)) OF
LTM-Candidate-r18
-- TAG-VARLTM-CONFIG-STOP
-- ASN1STOP
```

For UE variables such as the VarLTM-UE-Config, the IE VarLTM-UE-Config is used to store the generated UE configuration related to the received LTM candidate cell configurations, as given in Table-8 below.

```
TABLE 8
          VarLTM-UE-Config UE variable
-- ASN1START
-- TAG-VARLTM-CONFIG-START
VarLTM-UE-Config-r18-IEs ::= SEQUENCE {
  Ue-ltm-ConfigCandidateList-r18 UE-LTM-ConfigCandidateList-r18
}
UE-LTM-ConfigCandidateList-r18 ::= SEQUENCE (SIZE (1..maxNrofCellsLTM-r18)) OF
UE-LTM-Config-r18
UE-LTM-Candidate-r18 ::= SEQUENCE {
  ltm-CandidateId-r18 LTM-CandidateId-r18,
  ue-LTM-Config-r18 OCTET STRING,
}
-- TAG-VARLTM-CONFIG-STOP
-- ASN1STOP
```

Furthermore, 3GPP has defined dual connectivity, or more technically known as multi-radio dual connectivity, in specifications like TS 37.340. Below is a summary detailing the dual connectivity and the operations involving the measurement gaps in the context of dual connectivity.

Next-generation radio access network (NG-RAN) supports multi-radio dual connectivity (MR-DC) operation whereby the UE in an RRC_CONNECTED is configured to utilize radio resources provided by two distinct schedulers, located in two different NG-RAN nodes connected via a non-ideal backhaul, one providing NR access and the other one providing either evolved UMTS terrestrial radio access (E-UTRA) or NR access. One node acts as a master node (MN) and the other as a secondary node (SN). The MN and SN are connected via a network interface and at least the MN is connected to the core network. The NG-RAN supports NG-RAN E-UTRA-NR dual connectivity (NGEN-DC), in which the UE is connected to one ng-eNB (an E-UTRA base station that can connect to 5G core) that acts as the MN and one Gnb (5G base station) that acts as the SN. The NG-RAN also supports NR-E-UTRA Dual Connectivity (NE-DC), in which the UE is connected to one gNB that acts as the MN and one ng-eNB that acts as the SN.

From NR release 17 of the 3GPP onwards, the gNB may activate or deactivate SCG using RRC message. The UE may perform random access during SCG activation based on certain conditions. In wireless technologies such as NR and LTE, a RRC connected UE undertakes a range of measurements for one or more Radio Resource Management (RRM) objectives, positioning, and other purposes. Specifically, for RRM, the UE conducts measurements on reference signals like synchronization signal block (SSB), channel state information reference signal (CSI-RS), among others, and subsequently transmits these measurements to the network. According to the NR specification TS 38.300, the measurements required to facilitate connected mode mobility are categorized into a minimum of four distinct measurement types:
a. Intra-frequency NR measurements;
b. Inter-frequency NR measurements;
c. Inter-RAT measurements for E-UTRA; and/or
d. Inter-RAT measurements for UTRA.

For each measurement type, one or more measurement objects can be defined, with a measurement object defining parameters such as the carrier frequency to be monitored. Each measurement object can have one or more reporting configurations defined, where a reporting configuration outlines the criteria for reporting. The reporting criteria encompass event-triggered reporting, periodic reporting, and event-triggered periodic reporting. The linkage between a measurement object and a reporting configuration is established through a measurement identity, which associates a specific measurement object with a corresponding reporting configuration within the same radio access technology (RAT). This measurement identity is also utilized when transmitting the measurement results.

In the context of positioning, the UE has the capability to report SSB/CSI-RS measurements and may additionally report measurements based on supplementary reference signals like a positioning reference signal (PRS).

In addition, when the UE is required to conduct measurements across inter-frequency NR or inter-RAT, or intra-frequency measurements beyond the active downlink bandwidth part (BWP) where the SSB extends beyond an active DL BWP, the UE can leverage measurement gaps. The measurement gaps are configured by the network entity (e.g., gNB in NR) and involve a gap period during which no transmission or reception takes place. The configuration of a measurement gap includes parameters such as gap offset, gap length, repetition period, and measurement gap timing advance. The gap offset specifies the subframe where the measurement gap is positioned, while the gap length denotes the duration of the gap. The repetition period defines the frequency at which the measurement gap can occur.

Moreover, 3GPP has defined a number of measurement gap patterns. Each gap pattern corresponds to a gap length and a gap repetition period, for example, in NR release 16, there are 26 gap patterns defined. Measurement gap timing advance (mgta) specifies a timing advance value in ms. A gap occurs mgta milliseconds before the subframe given by the measurement gap offset.

Till NR release 16 of the 3GPP, the UE may be configured with a maximum of one measurement gap at any time. Measurement gaps are activated immediately after the configuration, from the measgap offset that comes after the reconfiguration. This leads to restrictions for the UE and network implementation.

In NR Release 17 of the 3GPP, the network may configure the UE with concurrent measurement gaps (also known as multiple measurement gaps) as given in Table-9 below.

TABLE 9

| | The number of simultaneously configured | | |
|---|---|---|---|
| Gap | measurement gap patterns | | |
| Combination | Per-FR1 | Per-FR2 | Per-UE |
| Configuration | measurement | measurement | measurement |
| Id | gap | gap | gap |
| 0 | 2 | 1 | 0 |
| 1 | 1 | 2 | 0 |
| 2 | 0 | 0 | 2 |
| 3Note 1 | 1 | 0 | 1 |
| 4Note 1 | 0 | 1 | 1 |
| 5Note 1 | 1 | 1 | 1 |

Note 1:
Gap Combination Configuration Id #3, #4, #5 will be only applied when the per-UE measurement gap is associated to measure PRS for any RSTD, PRS-RSRP, and UE Rx-Tx time difference measurement defined in TS 38.215.

Each measurement gap may be associated with one or multiple frequency layers, while each frequency layer may be associated with only one of the concurrent gaps. Each measured synchronization signal block (SSB) or long-term evolution (LTE) frequency is considered as one frequency layer. SSB and channel state information reference signal (CSI-RS) measurements in one measurement object (MO) are considered as different frequency layers. One of the measurement gaps may also be associated with the positioning reference signal (PRS), i.e., PRS also is considered as a frequency layer. In other words, each E-UTRA MO, or PRS is a frequency layer while NR MO may contain one or two frequency layers depending on whether the NR MO contains either of SSB and CSI-RS or both of them. The NR release 17 of the 3GPP also supports preconfigured measurement gaps (gaps that may be activated or deactivated based on some actions like a bandwidth part switch or SCell addition or SCell release or SCG addition or SCG release) and network controlled small gaps (NCSG). Multiple measurement gaps, preconfigured measurement gaps, and network-controlled small gaps (NCSG-small gaps which are also called interruptions) may be referred to together as measurement gap enhancements.

The measurement gaps may be configured by the network using one or more RRC messages like the RRC reconfiguration message (e.g., NR RRCReconfiguration message) or RRC resume message (e.g., NR RRCResume message) using, MeasGapConfig. An extract from 3GPP TS 38.331 of MeasGapConfig is given in Table-10 below, The IE MeasGapConfig specifies the measurement gap configuration and controls setup/release of measurement gaps.

TABLE 10
MeasGapConfig information element
-- ASN1START
-- TAG-MEASGAPCONFIG-START
MeasGapConfig ::= SEQUENCE {

| | |
|---|---|
| gapFR2 SetupRelease { GapConfig } | OPTIONAL, -- Need M |

```
  ...,
  [[
```

| | |
|---|---|
| gapFR1 SetupRelease { GapConfig } | OPTIONAL, -- Need M |
| gapUE SetupRelease { GapConfig } | OPTIONAL -- Need M |

```
  ]],
  [[
  gapToAddModList-r17 SEQUENCE (SIZE (1..maxNrofGapId-r17)) OF
GapConfig-r17 OPTIONAL, -- Need N
  gapToReleaseList-r17 SEQUENCE (SIZE (1..maxNrofGapId-r17)) OF
MeasGapId-r17 OPTIONAL, -- Need N
  posMeasGapPreConfigToAddModList-r17 PosMeasGapPreConfigToAddModList-
r17 OPTIONAL, -- Need N
  posMeasGapPreConfigToReleaseList-r17 PosMeasGapPreConfigToReleaseList-r17
OPTIONAL -- Need N
  ]]
}
GapConfig ::= SEQUENCE {
  gapOffset INTEGER (0..159),
  mgl ENUMERATED {ms1dot5, ms3, ms3dot5, ms4, ms5dot5, ms6},
  mgrp ENUMERATED {ms20, ms40, ms80, ms160},
  mgta ENUMERATED {ms0, ms0dot25, ms0dot5},
  ...,
  [[
  refServCellIndicator ENUMERATED {pCell, pSCell, mcg-FR2}
OPTIONAL -- Cond NEDCorNRDC
  ]],
  [[
```

| | |
|---|---|
| refFR2ServCellAsyncCA-r16 ServCellIndex | OPTIONAL, -- |

Cond AsyncCA

| | |
|---|---|
| mgl-r16 ENUMERATED {ms10, ms20} | OPTIONAL -- Cond |

```
PRS
  ]]
}
GapConfig-r17 ::= SEQUENCE {
  measGapId-r17 MeasGapId-r17,
  gapType-r17 ENUMERATED {perUE, perFR1, perFR2},
  gapOffset-r17 INTEGER (0..159),
  mgl-r17 ENUMERATED {ms1, ms1dot5, ms2, ms3, ms3dot5, ms4, ms5,
ms5dot5, ms6, ms10, ms20},
  mgrp-r17 ENUMERATED {ms20, ms40, ms80, ms160},
  mgta-r17 ENUMERATED {ms0, ms0dot25, ms0dot5, ms0dot75},
  refServCellIndicator-r17 ENUMERATED {pCell, pSCell, mcg-FR2}
OPTIONAL, -- Cond NEDCorNRDC
```

| | |
|---|---|
| refFR2-ServCellAsyncCA-r17 ServCellIndex | OPTIONAL, -- |

Cond AsyncCA

| | |
|---|---|
| preConfigInd-r17 ENUMERATED {true} | OPTIONAL, -- |

Need R

| | |
|---|---|
| ncsgInd-r17 ENUMERATED {true} | OPTIONAL, -- Need R |
| gapAssociationPRS-r17 ENUMERATED {true} | OPTIONAL, -- |

Need R

| | |
|---|---|
| gapSharing-r17 MeasGapSharingScheme | OPTIONAL, -- Need |

R

| | |
|---|---|
| gapPriority-r17 GapPriority-r17 | OPTIONAL, -- Need R |

```
  ...
}
PosMeasGapPreConfigToAddModList-r17 ::= SEQUENCE (SIZE
(1..maxNrofPreConfigPosGapId-r17)) OF PosGapConfig-r17
PosMeasGapPreConfigToReleaseList-r17 ::= SEQUENCE (SIZE
(1..maxNrofPreConfigPosGapId-r17)) OF MeasPosPreConfigGapId-r17
PosGapConfig-r17 ::= SEQUENCE {
  measPosPreConfigGapId-r17 MeasPosPreConfigGapId-r17,
  gapOffset-r17 INTEGER (0..159),
  mgl-r17 ENUMERATED {ms1dot5, ms3, ms3dot5, ms4, ms5dot5, ms6,
ms10, ms20},
  mgrp-r17 ENUMERATED {ms20, ms40, ms80, ms160},
  mgta-r17 ENUMERATED {ms0, ms0dot25, ms0dot5},
  gapType-r17 ENUMERATED {perUE, perFR1, perFR2},
  ...
}
MeasPosPreConfigGapId-r17 ::= INTEGER (1..maxNrofPreConfigPosGapId-r17)
-- TAG-MEASGAPCONFIG-STOP
-- ASN1STOP
```

As described above, MeasGapConfig may contain Measurement Gaps (MG) defined through two different ways—GapConfig without measurement gap identifiers, or GapConfig-r17 is defined with gap identifiers. The measurement gaps may be associated with the MO and the reference signals within the measurement object through RRC Configuration. E.g., MeasObjectNR can contain associatedMeasGapSSB-r17 or associatedMeasGapCSIRS-r17 which associates an SSB or CSI-RS reference signal (RS) to the measurement object. For non-terrestrial network (NTN), there may be further association using associatedMeasGapSSB2-v1720 or associatedMeasGapCSIRS2-v1720. For an E-UTRA measurement object, there could be an association defined using associatedMeasGap-r17 in the E-UTRA measurement object configuration. If the UE is configured with a measurement object that is not associated with any measurement gap, the UE associates them to the measurement gaps configured without an identifier (implicit association).

There is a need for different methods for configuring the UE with measurement gaps by the network for the LTM and for applying the configured measurement gaps. Thus, it would be advantageous to address the above-mentioned disadvantages or other shortcomings in the existing art as discussed above.

### SUMMARY

This summary is provided to introduce a selection of concepts, in a simplified format, which is further described in the detailed description of the disclosure. This summary is neither intended to identify key or essential inventive concepts of the disclosure nor is it intended for determining the scope of the disclosure.

According to one embodiment of the present disclosure, a method configuring one or more measurement gaps in a wireless network is disclosed herein. The method includes receiving a configuration message from a network device of the wireless network, wherein the configuration message provides information that comprises at least one of layer-1 (L1) measurement configuration for lower layer triggered mobility (LTM), a measurement gap (MG) configuration, and Layer-3 (L3) measurement configuration. The method further includes determining whether both the L1 measurement configuration for LTM and the L3 measurement configuration are available in the received configuration message. The method further includes configuring, based on the received configuration message, the one or more measurement gaps in a user equipment (UE) to perform the L1 measurements for LTM in response to determining that the L3 measurement configuration is not available in the received configuration message and performing the L1 measurements for LTM using the one or more configured measurement gaps.

The method further includes configuring, based on the received configuration message, the one or more measurement gaps in the UE to perform both L1 measurements for LTM and L3 measurements in response to determining that both the L1 measurement configuration for LTM and the L3 measurement configuration are available and performing the L1 measurements for LTM and the L3 measurements using the one or more configured measurement gaps. As usual for the configuration of measurements in RRC signaling, the L1 measurement configuration, LTM measurement configuration, and Measurement gap configuration may be received in different RRC messages and the UE maintains the received value from previous messages and considers such values as available in the received configuration message.

According to another embodiment of the present disclosure, a method for configuring one or more measurement gaps in the wireless network is disclosed herein. The method includes sending a UE capability enquiry message to the UE of the wireless network. The method further includes receiving, upon sending the UE capability enquiry message, UE capability information from the UE. The method further includes determining whether the received UE capability information indicates a capability to perform one of an inter-frequency LTM measurement without a gap and an intra-frequency LTM measurement without the gap. The method further includes configuring, based on the determined capability, the one or more measurement gaps configuration to perform the one of inter-frequency LTM measurements without gap and the intra-frequency LTM measurements without gap, wherein the network device sends the one or more configured measurement gaps to the UE by utilizing a configuration message.

According to another embodiment of the present disclosure, the UE for configuring one or more measurement gaps in the wireless network is disclosed herein. The UE includes a processor coupled with a memory and a communicator. The processor may receive the configuration message from the network device of the wireless network, wherein the configuration message provides information that comprises at least one of the L1 measurement configuration for LTM, the MG configuration, and the L3 measurement configuration. The processor may determine whether both the L1 measurement configuration for LTM and the L3 measurement configuration are available in the received configuration message. The processor may configure, based on the received configuration message, the one or more measurement gaps in the UE to perform the L1 measurements for LTM in response to determining that the L3 measurement configuration is not available in the received configuration message and may perform the L1 measurements for LTM using the one or more configured measurement gaps.

The processor may configure, based on the received configuration message, the one or more measurement gaps in the UE to perform both L1 measurements for LTM and L3 measurements in response to determining that both the L1 measurement configuration for LTM and the L3 measurement configuration are available and may perform the L1 measurements for LTM and the L3 measurements using the one or more configured measurement gaps. The processor may receive the L1 measurement configuration, LTM measurement configuration and Measurement gap configuration in different RRC messages and may maintain the received value from previous messages and consider such values as available in the received configuration message.

According to another embodiment of the present disclosure, the network device for configuring one or more measurement gaps in the wireless network is disclosed herein. The network device includes a processor coupled with the memory and the communicator. The processor may send the UE capability enquiry message to the UE of the wireless network. The processor may receive, upon sending the UE capability enquiry message, the UE capability information from the UE. The processor may determine whether the received UE capability information indicates a capability to perform one of the inter-frequency LTM measurements without the gap and the intra-frequency LTM measurements without the gap. The processor may configure, based on the determined capability, the one or more measurement gaps configuration to perform the one of inter-frequency LTM measurements without gap and the intra-frequency LTM measurements without gap, wherein the network device sends the one or more configured measurement gaps to the UE by utilizing the configuration message.

To further clarify the advantages and features of the present disclosure, a more particular description of the disclosure will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail in the accompanying drawings.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates a UE for configuring one or more measurement gaps in a wireless network according to an embodiment as disclosed herein;

FIG. 2 illustrates a network device for configuring one or more measurement gaps in the wireless network according to an embodiment as disclosed herein;

FIG. 3 illustrates a flow diagram of a method for configuring one or more measurement gaps for LTM measurements (alternative-1), according to an embodiment as disclosed herein;

FIG. 4 illustrates a flow diagram of a method for configuring the one or more measurement gaps for the LTM measurements (alternative-2) according to an embodiment as disclosed herein;

FIGS. 5A-5B illustrate flow diagrams of a method for configuring the one or more measurement gaps for the LTM measurements and L3 measurements (alternative-3) according to an embodiment as disclosed herein;

FIG. 6 illustrates a flow diagram of a method for configuring the one or more measurement gaps for the LTM measurements (alternative-4) by utilizing CU functionality and DU functionality according to an embodiment as disclosed herein; and

FIG. 7 illustrates a flow diagram of a method for configuring the one or more measurement gaps based on UE capability information according to an embodiment as disclosed herein.

Further, skilled artisans will appreciate those elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

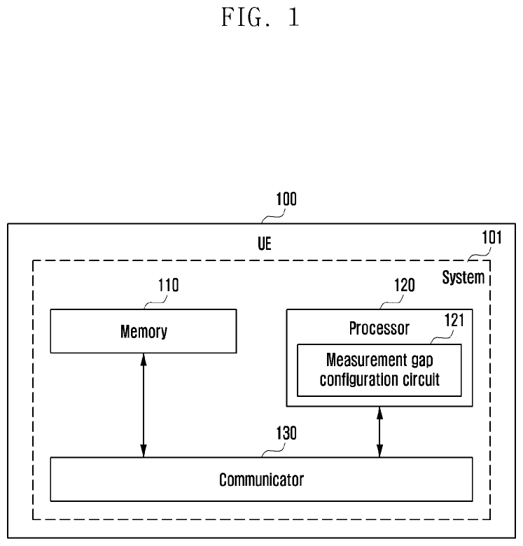

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

For the purpose of promoting an understanding of the principles of the disclosure, reference will now be made to the embodiment illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this specification to “an aspect,” “another aspect” or similar language means that a particular feature, structure, or characteristic described in connection with the embodiment is included in at least one embodiment of the present disclosure. Thus, appearances of the phrase “in an embodiment,” “in one embodiment,” “in another embodiment,” and similar language throughout this specification may but do not necessarily, all refer to the same embodiment.

The terms “comprise,” “comprising,” or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

Referring now to the drawings, and more particularly to FIGS. 1 to 7, where similar reference characters denote corresponding features consistently throughout the figures, there are shown preferred embodiments.

FIG. 1 illustrates a UE 100 for configuring one or more measurement gaps in a wireless network according to an embodiment as disclosed herein. Examples of the UE 100 may include, but are not limited to, a smartphone, a tablet computer, a personal digital assistance (PDA), an Internet of Things (IoT) device, etc. The wireless network may include, for example, but is not limited to, one or more UEs 100a-100n, one or more base stations, one or more evolved node Bs (eNBs), one or more gNodeBs, and one or more NR gNodeBs.

In an embodiment, the UE 100 comprises a system 101. The system 101 may include a memory 110, a processor 120, and a communicator 130.

In an embodiment, the memory 110 stores instructions to be executed by the processor 120 for configuring one or more measurement gaps in the wireless network, as discussed throughout the disclosure. The memory 110 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 110 may, in some examples, be considered a non-transitory storage medium. The term “non-transitory” may indicate that the storage medium is not embodied in a carrier wave or a propagated signal. However, the term “non-transitory” should not be interpreted that the memory 110 is non-movable. In some examples, the memory 110 can be configured to store larger amounts of information than the memory. In certain examples, a non-transitory storage medium may store data that can, over time, change (e.g., in Random Access Memory (RAM) or cache). The memory 110 can be an internal storage unit, or the memory 110 can be an external storage unit of the UE 100, a cloud storage, or any other type of external storage.

The processor 120 communicates with the memory 110, and the communicator 130. The processor 120 is configured to execute instructions stored in the memory 110 and to perform various processes for configuring the one or more measurement gaps in the wireless network, as discussed throughout the disclosure. The processor 120 may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

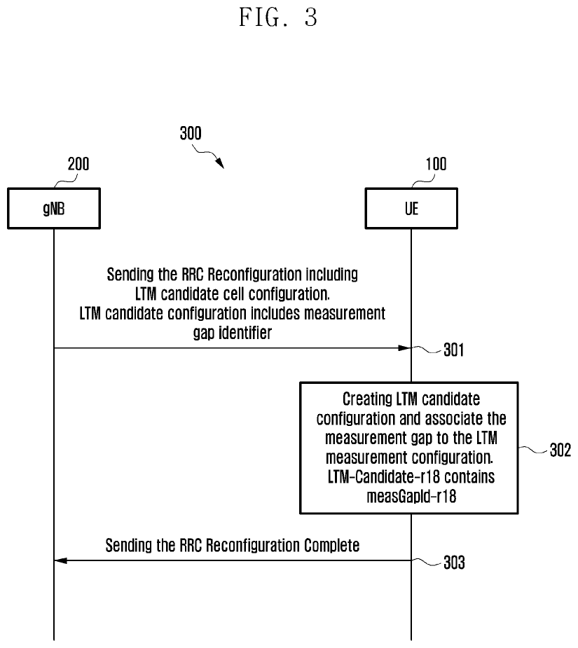

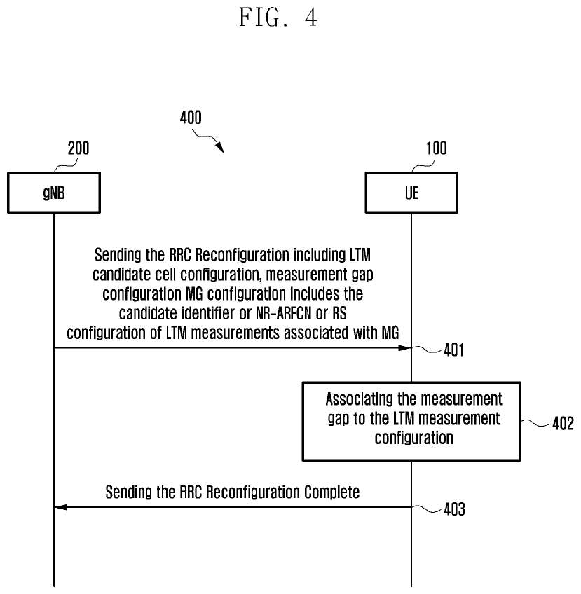

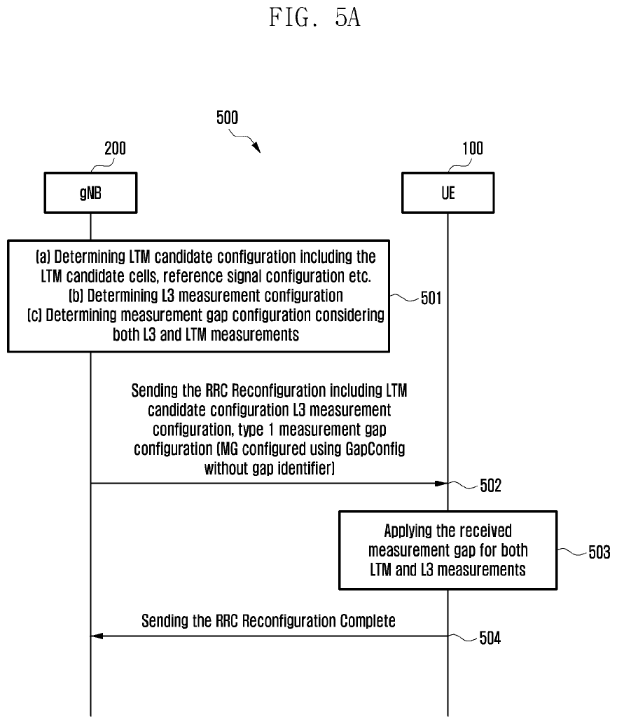

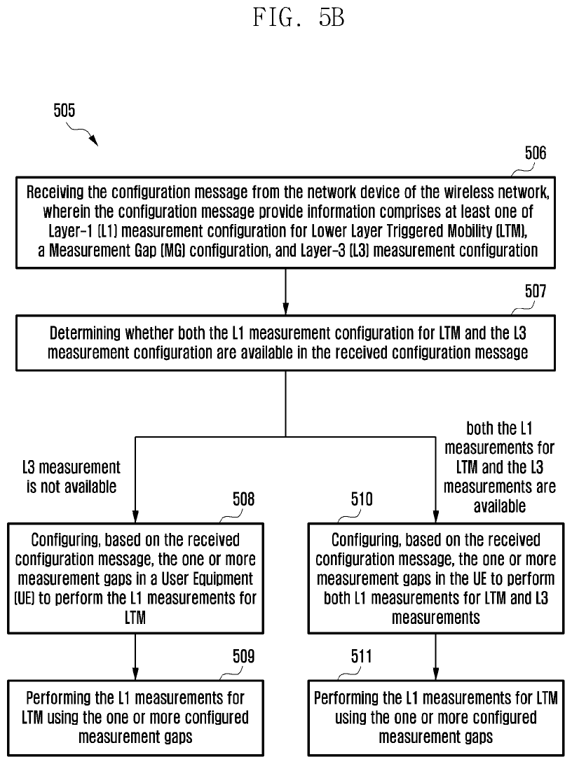

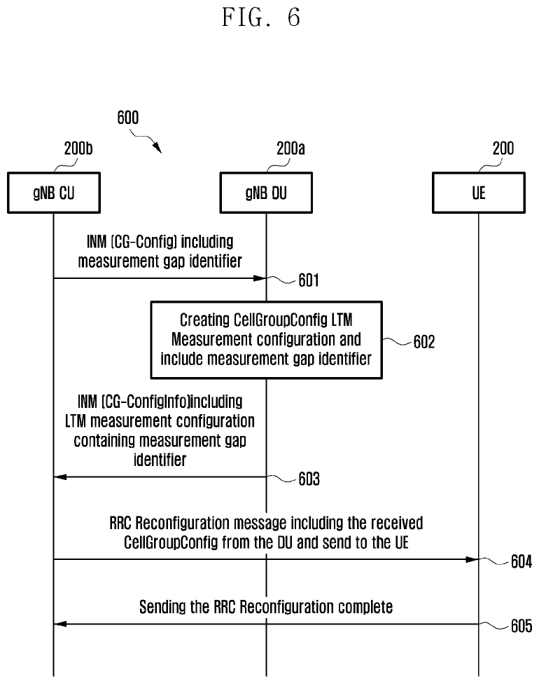

In one embodiment, the processor 120 may include a measurement gap configuration circuit 121 for configuring the one or more measurement gaps in the wireless network, as described in conjunction with FIG. 3, FIG. 4, FIG. 5A, FIG. 5B, and FIG. 6. In one embodiment, the measurement gap configuration circuit 121 is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In one or more embodiments, the measurement gap configuration circuit 121 may execute multiple operations to configure the one or more measurement gaps, which are given below.

The measurement gap configuration circuit 121 may receive a configuration message from a network device of the wireless network. The configuration message provides information that comprises at least one of layer-1 (L1) measurement configuration for lower layer triggered mobility (LTM), a measurement gap (MG) configuration, and Layer-3 (L3) measurement configuration. In one embodiment, the configuration message is received in at least one of a radio resource control (RRC) reconfiguration message and an RRC resume message in the wireless network.

In one embodiment, the MG configuration is to be used for the L1 measurement configuration for LTM, and both L1 measurement configuration for LTM and L3 measurement configuration, and the MG is received in at least one of radio resource control information element (RRC IEs) GapConfig and GapConfig-r17. In one embodiment, the MG is to be used for the L1 measurement configuration for LTM, and both L1 measurement configuration for LTM and L3 measurement configuration, and the MG is configured as per-UE gap(s) and/or per-frequency range (FR) gap(s), wherein the FR is either a frequency range1 (FR1) or a frequency range 2 (FR2). In one embodiment, the one or more measurement gaps for the LTM measurements are synchronized with the one or more measurement gaps for the L3 measurements.

The measurement gap configuration circuit 121 may further determine whether both the L1 measurement configuration for LTM and the L3 measurement configuration are available in the received configuration message, as described in conjunction with FIG. 5A and FIG. 5B.

The measurement gap configuration circuit 121 may further configure, based on the received configuration message, the one or more measurement gaps in a UE to perform the L1 measurements for LTM in response to determining that the L3 measurement configuration is not available in the received configuration message. The measurement gap configuration circuit 121 may further perform the L1 measurements for LTM using the one or more configured measurement gaps.

The measurement gap configuration circuit 121 may further configure, based on the received configuration message, the one or more measurement gaps in the UE to perform both L1 measurements for LTM and L3 measurements in response to determining that both the L1 measurement configuration for LTM and the L3 measurement configuration are available. The measurement gap configuration circuit 121 may further perform the L1 measurements for LTM and the L3 measurements using the one or more configured measurement gaps.

The communicator 130 is configured for communicating internally between internal hardware components and with external devices (e.g., server) via one or more networks (e.g., radio technology). The communicator 130 includes an electronic circuit specific to a standard that enables wired or wireless communication.

Although FIG. 1 shows various hardware components of the UE 100, but it is to be understood that other embodiments are not limited thereon. In other embodiments, the UE 100 may include less or more number of components. Further, the labels or names of the components are used only for illustrative purposes and do not limit the scope of the disclosure. One or more components can be combined to perform the same or substantially similar functions to configure the one or more measurement gaps in the wireless network.

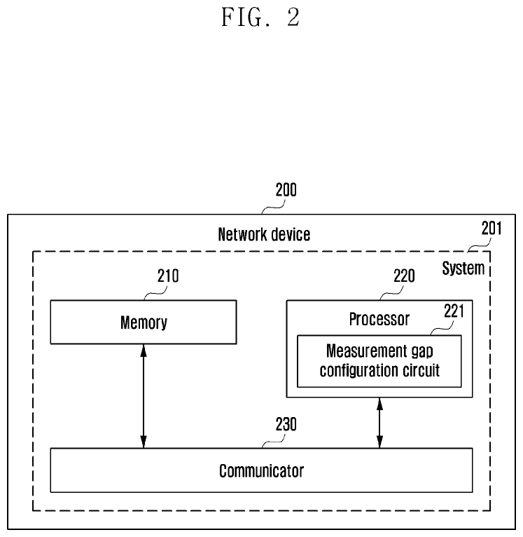

FIG. 2 illustrates a network device 200 for configuring one or more measurement gaps in the wireless network according to an embodiment as disclosed herein. Examples of the network device 200 may include, but is not limited to, one or more base stations, eNB, gNodeB, and NR gNodeB, etc.

In an embodiment, the network device 200 comprises a system 201. The system 201 may include a memory 210, a processor 220, and a communicator 230.

In an embodiment, the memory 210 stores instructions to be executed by the processor 220 for configuring the one or more measurement gaps in the wireless network, as discussed throughout the disclosure. The memory 210 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 210 may, in some examples, be considered a non-transitory storage medium. The term “non-transitory” may indicate that the storage medium is not embodied in a carrier wave or a propagated signal. However, the term “non-transitory” should not be interpreted that the memory 210 is non-movable. In some examples, the memory 210 can be configured to store larger amounts of information than the memory. In certain examples, a non-transitory storage medium may store data that can, over time, change (e.g., in Random Access Memory (RAM) or cache). The memory 210 can be an internal storage unit, or the memory 210 can be an external storage unit of the network device 200, a cloud storage, or any other type of external storage.

The processor 220 communicates with the memory 210, and the communicator 230. The processor 220 is configured to execute instructions stored in the memory 210 and to perform various processes for configuring the one or more measurement gaps in the wireless network, as discussed throughout the disclosure. The processor 220 may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

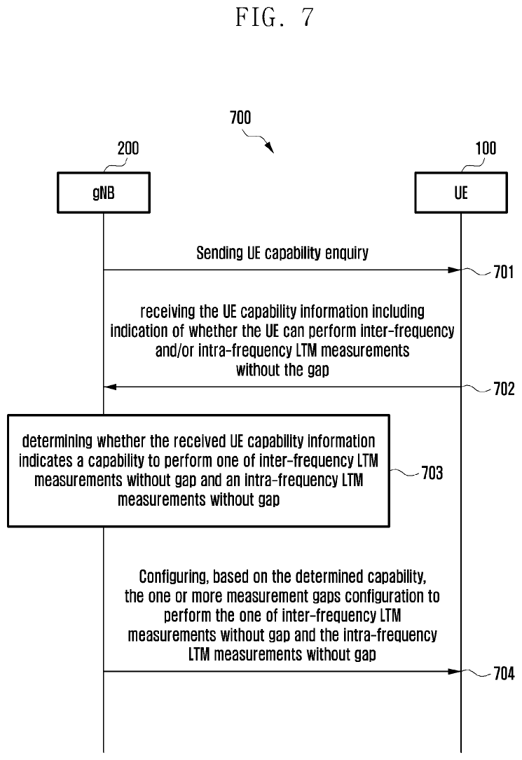

In one embodiment, the processor 220 may include a measurement gap configuration circuit 221 for configuring the one or more measurement gaps in the wireless network, as described in conjunction with FIG. 3, FIG. 4, FIG. 5A, FIG. 5B, FIG. 6, and FIG. 7. In one embodiment, the measurement gap configuration circuit 221 is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In one or more embodiments, the measurement gap configuration circuit 221 may execute multiple operations to configure the one or more measurement gaps, which are given below, as described in conjunction with FIG. 3, FIG. 4, FIG. 5A, FIG. 5B, FIG. 6, and FIG. 7.

In one embodiment, the measurement gap configuration circuit 221 may send a UE capability enquiry message to the UE 100 of the wireless network. In one embodiment, the measurement gap configuration circuit 221 may further receive, upon sending the UE capability enquiry message, UE capability information from the UE 100. In one embodiment, the UE capability information indicates whether the UE 100 is capable of performing the inter-frequency L1 measurements for LTM without the gap and is separately sent from the information whether the UE 100 is capable of performing inter-frequency L3 measurements without the measurement gap. In one embodiment, the UE capability information indicates whether the UE 100 is capable of performing the intra-frequency L1 measurements for LTM without the gap and is separately sent from the information whether the UE 100 is capable of performing intra-frequency L3 measurements without the measurement gap. There may be two separate information (two separate bits), one of which indicates that the UE 100 is capable of performing inter-frequency L3 measurements without the measurement gap and another one which indicates that the UE 100 is capable of performing inter-frequency L3 measurements without the measurement gap.

In one embodiment, the measurement gap configuration circuit 221 may further determine whether the received UE capability information indicates a capability to perform one of the inter-frequency LTM measurements without the gap and the intra-frequency LTM measurements without the gap. In one embodiment, the measurement gap configuration circuit 221 may further configure, based on the determined capability, the one or more measurement gaps configuration to perform the one of inter-frequency LTM measurements without gap and the intra-frequency LTM measurements without gap, wherein the network device 200 sends the one or more configured measurement gaps to the UE 100 by utilizing a configuration message.

In one embodiment, the LTM configuration comprises at least one of the LTM candidate cell information and reference signal configuration information. In one embodiment, the one or more measurement gaps are determined by a Centralized Unit (CU) of the network device 200 and the CU informs the one or more determined measurement gaps for the LTM measurements to a Distribution Unit (DU) of the network device 200 by utilizing an F1 Application Protocol (F1AP) message, as described in conjunction with FIG. 6. Alternatively, the CU may send the LTM candidate configuration and the UE 100 Capabilities. DU of the network device 200 may determine the measurement gaps based on the received capabilities and the LTM candidate configuration. DU of the network device 200 also may receive the L3 measurement configuration and the measurement gap requirements for the L3 measurements (such as the need for gaps, need for network controlled small gaps (NCSG) and the need for interruptions) from the CU of the network. DU of the network device 200 may generate the measurement gaps considering the LTM candidate configurations, the received capabilities, L3 measurement configuration and the measurement gap requirements for the L3 measurements. DU of the network device 200 further communicates the measurement gaps thus generated to CU of the network device 200 over F1AP interface. CU of the network device 200 communicates the generated measurement gaps to the UE 100.

Although FIG. 2 shows various hardware components of the network device 200, but it is to be understood that other embodiments are not limited thereon. In other embodiments, the network device 200 may include less or more number of components. Further, the labels or names of the components are used only for illustrative purposes and do not limit the scope of the disclosure. One or more components can be combined to perform the same or substantially similar functions to configure the one or more measurement gaps in the wireless network.

FIG. 3 illustrates a flow diagram of a method 300 for configuring one or more measurement gaps for LTM measurements (alternative-1) according to an embodiment as disclosed herein.

At step 301, the method 300 includes sending an RRC reconfiguration including LTM candidate cell configuration. LTM candidate configuration includes measurement gap identifier. At step 302, the method 300 includes creating, after receiving the RRC reconfiguration, the LTM candidate configuration and associating the measurement gap to the LTM measurement configuration. LTM-Candidate-r18 contains measGapId-r18. At step 303, the method 300 includes sending, after creating the LTM candidate configuration and associating the measurement gap, the RRC reconfiguration complete to the gNB 200.

FIG. 4 illustrates a flow diagram of a method 400 for configuring the one or more measurement gaps for the LTM measurements (alternative-2) according to an embodiment as disclosed herein.

At step 401, the method 400 includes sending a RRC reconfiguration including LTM candidate cell configuration, measurement gap configuration MG configuration includes the candidate identifier or NR-ARFCN or RS configuration of LTM measurements associated with MG. At step 402, the method 400 includes associating, upon receiving the RRC reconfiguration, the measurement gap to the LTM measurement configuration. At step 403, the method 400 includes sending, after associating the measurement gap, an RRC reconfiguration complete to the gNB 200.

FIGS. 5A-5B illustrate flow diagrams of a method (500/505) for configuring the one or more measurement gaps for the LTM measurements and L3 measurements (alternative-3) according to an embodiment as disclosed herein.

Referring to FIG. 5A: at step 501, the method 500 includes performing, by the gNB 200, one or more operations comprising (a) determining LTM candidate configuration including the LTM candidate cells, reference signal configuration, etc.; (b) determining L3 measurement configuration; and (c) Determining measurement gap configuration considering both L3 and LTM measurements. At step 502, the method 500 includes sending, by the gNB 200, after performing the one or more operations, sending the RRC Reconfiguration including LTM candidate configuration, L3 measurement configuration, type 1 measurement gap configuration (such as MG configured using GapConfig without gap identifier) to the UE 100. At step 503, the method 500 includes applying, by the UE 100, the received measurement gap for both LTM and L3 measurements. At step 504, the method 500 includes sending, after applying the received measurement gap, the RRC Reconfiguration Complete to the gNB 200 as an acknowledgement.

Referring to FIG. 5B: at step 506, the method 505 includes receiving the configuration message from the network device 200 of the wireless network. The configuration message provides information that comprises at least one of the L1 measurement configuration for the LTM, the MG configuration, and the L3 measurement configuration. At step 507, the method 505 includes determining whether both the L1 measurement configuration for LTM and the L3 measurement configuration are available in the received configuration message.

At steps 508-509, the method 505 includes configuring, based on the received configuration message, the one or more measurement gaps in the UE 100 to perform the L1 measurements for LTM in response to determining that the L3 measurement configuration is not available in the received configuration message. The method 505 further includes performing the L1 measurements for LTM using the one or more configured measurement gaps. At steps 510-511, the method 505 includes configuring, based on the received configuration message, the one or more measurement gaps in the UE 100 to perform both L1 measurements for LTM and L3 measurements in response to determining that both the L1 measurement configuration for LTM and the L3 measurement configuration are available. The method 505 further includes performing the L1 measurements for LTM and the L3 measurements using the one or more configured measurement gaps.

In one embodiment, the measurement gaps (i.e., one or more measurement gaps) for the LTM measurements are shared with the measurement gaps for the L3 measurements. In one embodiment, the gNB 200 configures the measurement gaps for the LTM measurements and the L3 measurements through RRC IE GapConfig. So, in this embodiment, the UE 100 may use the measurement gaps configured through a GapConfig IE for both the LTM measurements and the L3 measurements.

In one embodiment, the gNB 200 may configure the UE 100 with measurement gaps for the LTM measurements and the L3 measurements through the RRC IE GapConfig and they are set up or released through the RRC IEs gapUE, gapFR1, and gapFR2. Thus, in this embodiment, the UE 100 may use the measurement gaps configured through the GapConfig IE which are set up or released through the RRC IEs gapUE, gapFR1, and gapFR2 for both the LTM measurements and the L3 measurements.

In one embodiment, if the NR gNB 200 has either configured a per-UE measurement gap or one or more per-FR measurement gaps for the FR for which the UE 100 is required to perform the measurements, through a GapConfig RRC IE and no measurement gap is configured explicitly for the LTM measurements for a particular frequency layer, the UE 100 may use the measurement gap(s) configured through the GapConfig RRC IE for the LTM measurements.

In one embodiment, the gNB 200 may configure the UE 100 with measurement gaps for the LTM measurements and the L3 measurements through an RRC IE GapConfig-r17 and they are set up through an RRC IEs gapToAddModList-r17 and released through a gapToReleaseList-r17. Thus, in this embodiment, the UE 100 may use the measurement gaps configured through a GapConfig-r17 IE which are set up through the RRC IEs gapToAddModList-r17 and released through the gapToReleaseList-r17 for both the LTM measurements and the L3 measurements.

In one embodiment, the gNB 200 may configure the UE 100 with measurement gaps for the LTM measurements and the L3 measurements through the RRC IE GapConfig-r17 but they are set up through RRC IEs which are used for the measurement gaps for the LTM measurements (e.g., LtmgapToAddModList-r17) and released through the RRC IEs which are used for the measurement gaps for the LTM measurements (e.g., LtmgapToReleaseList-r17). Thus, in this embodiment, the UE 100 may use the measurement gaps configured through the GapConfig-r17 IE which are set up through RRC IEs gapToAddModList-r17 and released through gapToReleaseList-r17 for the L3 measurements, and the measurement gaps configured through the GapConfig-r17 IE which is set up through RRC IEs LtmgapToAddModList-r17 and released through the LtmgapToReleaseList-r17 for the LTM measurements.

In one embodiment, the gNB 200 may inform the UE 100 of the measurement gap Id of the measurement gap to be used for performing the LTM measurements. In one embodiment, this may be communicated implicitly, e.g., based on the configuration of measurement gap ID in the measurement object configuration for L3 measurements. For example, if there is a measurement gap configured through the GapConfig-r17 IE which is set up through the RRC IEs gapToAddModList-r17 for a frequency (e.g., new radio absolute radio frequency channel number (NR-ARFCN) and the SubCarrierSpacing (SCS)) for L3 measurements and there is an LTM candidate cell configured with the same frequency and there is a measurement gap identifier available in the measurement object of the L3 measurements, the UE 100 may use the same measurement gap for the LTM measurements.

In one embodiment, the gNB 200 may inform the UE 100 of the measurement gap Id of the measurement gap to be used for performing the LTM measurements by adding a flag to indicate the gaps are for the LTM measurements in GapConfig-R17.

In one embodiment, the gNB 200 may inform the UE 100 of the measurement gap ID along with the frequency information for the LTM measurements. In an embodiment, the gNB 200 may inform the UE 100 of the measurement gap ID along with the frequency information and the reference signal information for the LTM measurements.

In one embodiment, the gNB 200 may inform the UE 100 of the measurement gap ID in the ASN.1 IE used for configuring the LTM measurements.

In one embodiment, the gNB 200 may inform the UE 100 of the measurement gap ID in the ASN.1 SEQUENCE used for at least one of the following:
a. Configurations for L1 measurement RS are provided under ServingCellConfig for the serving cells;
b. Configurations for L1 measurement RS are provided separately from ServingCellConfig for the serving cells and CellGroupConfig for the candidate cells;
c. Configurations for L1 measurement RS are provided under CellGroupConfig for the candidate cells; and/or
d. L3 measurement configuration such as MeasObjectNR which may be used for identifying the reference signal and/or NR ARFCN for the measurements for LTM.

In one embodiment, the network device such as the gNB 200 in the NR configures dedicated measurement gap(s) for the LTM measurements. Such a measurement gap may not be shared for the L3 measurements.

In one embodiment, the network device such as NR gNB 200 configures the UE 100 with the measurement gaps for the LTM measurements, and the measurement gaps for the L3 measurements separately.

In one embodiment, the network device such as NR gNB 200 configures the UE 100 with the measurement gaps for the LTM measurements, and the measurement gaps for the L3 measurements separately using different RRC information elements (different RRC IEs).

In one embodiment, the network device such as NR gNB 200 configures the UE 100 with the measurement gaps for the LTM measurements using an information element used only for LTM measurement gap configuration (i.e., not for L3 measurement gap configuration), as shown in Table-11 below.

```
TABLE 11
LTMGapConfig-r18: = SEQUENCE {
  gapOffset-r17 INTEGER (0..159),
  mgl-r17 ENUMERATED {ms1dot5, ms3, ms3dot5, ms4, ms5dot5,
ms6 },
  mgrp-r17 ENUMERATED {ms20, ms40, ms80, ms160},
  mgta-r17 ENUMERATED {ms0, ms0dot25, ms0dot5},
  gapType-r17 ENUMERATED {perUE, perFR1, perFR2},
  <Additional IEs specific to LTM measurement gaps>
  ...
}
```

In one embodiment, the additional IEs include an indication that mentions that the gaps are the LTM measurement gaps, a gap priority for the LTM measurement gap, and a gap-sharing configuration for the LTM measurement gaps.

In one embodiment, if the UE 100 is provided with gap priority for the LTM measurement gaps and the UE 100 may detect a gap collision between the LTM measurement gaps (partial or fully overlap in the time domain for one or more LTM measurement gaps) or if the UE 100 may detect a gap collision between the LTM and L3 measurement gaps (partial or fully overlap in the time domain for one or more LTM measurement gaps and one or more L3 measurement gaps), the UE 100 may use the measurement gap with highest measurement gap priority for performing the measurements associated with that gap. The UE 100 may drop the measurement gap with lower priority, i.e., don't use the measurement gap with lower measurement gap priority for performing the measurements that require that measurement gap. For example, there may be an LTM measurement in a measurement occasion in a frequency and there is no L3 measurement in the same measurement occasion and both LTM measurements and L3 measurements of the frequency use a measurement gap according to the measurement gap identifier. There may be an L3 measurement in the same measurement occasion in another frequency using the same measurement gap but with a lower priority. The UE 100 uses the measurement gaps for performing the LTM measurements and does not perform L3 measurements.

In one embodiment, if the UE 100 is provided with a gap-sharing configuration for LTM measurement gaps, the UE 100 may divide an available gap duration according to the ratio provided in the gap-sharing configuration among the measurement gaps with the same priority. Measurement gaps in the above embodiment may be LTM measurement gaps or L3 measurement gaps or the gaps shared across LTM and L3 measurements.

In one embodiment, the measurement gaps configured for LTM measurements include the following information elements (IE): gap Type (per-UE, per-FR1, or per-FR2), gap offset, gap length, gap repetition, and timing advance related to the gap.

In one embodiment, the measurement gaps configured by the network device such as NR gNB 200 for the UE 100 for the LTM measurements may be a per-UE gap or a per-FR gap (e.g., per-FR1 gap or per-FR2 gap).

In one embodiment, the NR gNB 200 may configure the NR UE 100 with the LTM measurement gaps using the GapConfig-r17 IE (as mentioned above). In one embodiment, when the gNB 200 may configure the NR UE 100 with the LTM measurement gaps using the GapConfig-R17 IE, the gNB 200 may set the mgl-r17 to at least one of the values {ms1, ms1dot5, ms2, ms3, ms3dot5, ms4, ms5, ms5dot5, ms6}.

In one embodiment, when the gNB 200 may configure the NR UE 100 with the LTM measurement gaps using GapConfig-R17 IE, the gNB excludes configuring the gap length 10 ms and/or 20 ms for the mgl-r17 field.

In one embodiment, the NR gNB 200 may configure the NR UE 100 with the LTM measurement gaps using the GapConfig RRC IE. If the measurement gap is configured only for the LTM measurements, the gNB 200 may exclude configuring mgl-r16 IE. In one embodiment, the gNB 200 may indicate that the gap may be used for the LTM measurements using a flag.

In one embodiment, if the NR gNB 200 has either configured a per-UE measurement gap or one or more per-FR measurement gaps for the FR for which the UE 100 is required to perform the measurements, through the GapConfig RRC IE and no other measurement gap is configured, the UE 100 may use the measurement gap(s) configured through the GapConfig RRC IE for the LTM measurements also.

In one embodiment, if the NR gNB 200 has either configured a per-UE measurement gap or one or more per-FR measurement gaps for the FR for which the UE 100 is required to perform the measurements, through the GapConfig RRC IE and no measurement gap is configured explicitly for the LTM measurements, the UE 100 may use the measurement gap(s) configured through the GapConfig RRC IE for the LTM measurements.

FIG. 6 illustrates a flow diagram of a method 600 for configuring the one or more measurement gaps for the LTM measurements (alternative-4) by utilizing centralized unit (CU) functionality and distributed unit (DU) functionality according to an embodiment as disclosed herein.

At step 601, the gNB CU 200b may allocate the one or more measurement gaps for the LTM measurements and inform the gNB DU 200a through an F1AP interface and using an RRC inter-node message (INM) such as CG-ConfigInfo. In one embodiment, the one or more measurement gaps for the LTM measurements are decided and configured by the gNB CU 200b. In one embodiment, the gNB CU 200b may inform the one or more measurement gaps for the LTM measurements to the gNB DU 200a through the F1AP message. In one embodiment, the gNB DU 200a is a source DU. In one embodiment, the gNB DU 200a is a target DU. In an embodiment, the gNB DU 200a is both source DU and target DU.

In one embodiment, the gNB CU 200b may inform the measurement gaps to the gNB DU 200a through the INM (Inter-Node RRC message) within the F1AP message. In one embodiment, the gNB CU 200b may inform the gNB DU 200a through a CG-ConfigInfo Inter-Node RRC message. In one embodiment, the gNB CU 200b may inform the gNB DU 200a through the CG-ConfigInfo Inter-Node RRC message and include that the gap is for the LTM measurements.

In one embodiment, gNB CU 200b informs the gNB DU 200a of the measurement gap configuration including at least one measurement gap identifier, applicable for a candidate cell, and the gNB DU 200a, at steps 602, 603 and 604, may include the measurement gap identifier in the LTM measurement configuration sent to the UE 100 such as:
a. Configurations for L1 measurement RS are provided under ServingCellConfig for the serving cells;
b. Configurations for L1 measurement RS are provided separately from ServingCellConfig for the serving cells and CellGroupConfig for the candidate cells;
c. Configurations for L1 measurement RS are provided under CellGroupConfig for the candidate cells; and/or
d. L3 measurement configuration such as MeasObjectNR which may be used for identifying the reference signal and/or NR ARFCN for the measurements for LTM.

In one embodiment, the gNB CU 200b may inform the gNB DU 200a of the measurement gap configuration including at least one measurement gap identifier, applicable for the NR-ARFCN and the gNB DU 200a may include the measurement gap identifier in the LTM measurement configuration sent to the UE 100 such as:
a. Configurations for L1 measurement RS are provided under ServingCellConfig for the serving cells;
b. Configurations for L1 measurement RS are provided separately from ServingCellConfig for the serving cells and CellGroupConfig for the candidate cells;
c. Configurations for L1 measurement RS are provided under CellGroupConfig for the candidate cells; and/or.
d. L3 measurement configuration such as MeasObjectNR which may be used for identifying the reference signal and/or NR ARFCN for the measurements for LTM.

In one embodiment, the gNB CU 200b informs the gNB DU 200a of the measurement gap configuration including at least the measurement gap identifier, applicable for a reference signal (in NR-ARFCN) and the gNB DU 200a may include the measurement gap identifier in the LTM measurement configuration sent to the UE such as:
a. Configurations for L1 measurement RS are provided under ServingCellConfig for the serving cells;
b. Configurations for L1 measurement RS are provided separately from ServingCellConfig for the serving cells and CellGroupConfig for the candidate cells;
c. Configurations for L1 measurement RS are provided under CellGroupConfig for the candidate cells; and/or
d. L3 measurement configuration such as MeasObjectNR which may be used for identifying the reference signal and/or NR ARFCN for the measurements for LTM.

Alternately Gnb-CU may receive the measurement gap configuration from the gNB DU 200a.

At steps 604-605, in one embodiment, the gNB CU 200b may configure the UE 100 with the measurement gap identifier for measuring a candidate cell (candidate cell's reference signals) for LTM measurements. In one embodiment, the gNB CU 200b may include the measurement gap identifier for the LTM measurements for a candidate cell along with the LTM candidate configuration given in Table-12 below.

```
TABLE 12
LTM-Candidate-r18 ::= SEQUENCE {
  ltm-CandidateId-r18 LTM-CandidateId-r18,
  ltm-Config-r18 OCTET STRING (CONTAINING RRCReconfiguration),
    measGapId-r18 MeasGapId-r17 OPTIONAL -- Need R,
  ...
}
```

In the above embodiment, the measurement gap with the measurement gap identifier, measGapId-r18 may be used for the LTM measurements for the LTM candidate cell with candidate cell identifier LTM-CandidateId-r18. If there are multiple LTM candidates, whose measurements require the same measurement gap, the gNB 200 configures the same value of measGapId-r18 for all of them.

In one embodiment, the UE 100 may store the measurement gap identifier associated with the LTM candidate configuration in the UE variable such as VarLTM-Config. In one embodiment, the UE 100 may store the measurement gap identifier associated with the LTM candidate configuration for MCG and SCG in two independent UE variables such as VarLTM-Config.

In one embodiment, the gNB CU 200b may inform the UE 100 of the measurement gap configuration including at least one measurement gap identifier, applicable for a frequency (NR-ARFCN).

In one embodiment, the gNB CU 200b may inform the UE 100 of the measurement gap configuration including at least one measurement gap identifier, applicable for a reference signal in the NR-ARFCN.

In one embodiment, the gNB CU 200b may inform the UE 100 of the measurement gap configuration including at least a measurement gap identifier, applicable for a frequency (NR-ARFCN) or a reference signal in the NR-ARFCN in the measurement gap configuration (GapConfig or GapConfig-r17 or any other similar structure), as shown in Table-13 below.

TABLE 13
An example is given below:

| GapConfig-r17 ::= SEQUENCE { | |
|---|---|
| measGapId-r17 MeasGapId-r17, | |
| gapType-r17 ENUMERATED {perUE, perFR1, perFR2}, | |
| gapOffset-r17 INTEGER (0...159), | |
| mgl-r17 ENUMERATED {ms1, ms1dot5, ms2, ms3, ms3dot5, | |
| ms4, ms5, ms5dot5, ms6, ms10, ms20}, | |
| mgrp-r17 ENUMERATED {ms20, ms40, ms80, ms160}, | |
| mgta-r17 ENUMERATED {ms0, ms0dot25, ms0dot5, | |
| ms0dot75}, | |
| refServCellIndicator-r17 ENUMERATED {pCell, pSCell, mcg- | |
| FR2} OPTIONAL, -- Cond NEDCorNRDC | |
| refFR2-ServCellAsyncCA-r17 | ServCellIndex |
| OPTIONAL, -- Cond AsyncCA | |
| preConfigInd-r17 ENUMERATED {true} | OPTIONAL, |
| -- Need R | |
| ncsgInd-r17 ENUMERATED {true} | OPTIONAL, |
| -- Need R | |
| gapAssociationPRS-r17 | ENUMERATED {true} |
| OPTIONAL, -- Need R | |
| gapSharing-r17 MeasGapSharingScheme | OPTIONAL, |
| -- Need R | |
| gapPriority-r17 GapPriority-r17 | OPTIONAL, -- |

```
Need R
    [[
Ltm-NR-ARFCN NR-ARFCN OPTONAL, -- Need R
LTM-RefSignal ENUMERATED {ssb, csi-rs, both}
    OPTIONAL, - Need R
  ]]
  ...
}
```

In one embodiment, the gNB CU 200b may inform the UE 100 of the measurement gap configuration including at least one measurement gap identifier, by providing the candidate cell identifier in the measurement gap configuration (GapConfig or GapConfig-r17 or any other similar structure), as shown in Table-14 below.

```
TABLE 14
GapConfig-r17: = SEQUENCE {
  measGapId-r17 MeasGapId-r17,
  gapType-r17 ENUMERATED {perUE, perFR1, perFR2},
  gapOffset-r17 INTEGER (0.159),
  mgl-r17 ENUMERATED {ms1, ms1dot5, ms2, ms3, ms3dot5, ms4,
ms5, ms5dot5, ms6, ms 10, ms20},
  mgrp-r17 ENUMERATED {ms20, ms40, ms80, ms160},
  mgta-r17 ENUMERATED {ms0, ms0dot25, ms0dot5, ms0dot75},
  refServCellIndicator-r17 ENUMERATED {pCell, pSCell, mcg-FR2}
OPTIONAL, -- Cond NEDCorNRDC
```

| | |
|---|---|
| refFR2-ServCellAsyncCA-r17 ServCellIndex | OPTIONAL, |

-- Cond AsyncCA

| | |
|---|---|
| preConfigInd-r17 ENUMERATED {true} | OPTIONAL, -- |

Need R

| | |
|---|---|
| ncsgInd-r17 ENUMERATED {true} | OPTIONAL, -- |

Need R

| | |
|---|---|
| gapAssociationPRS-r17 ENUMERATED {true} | OPTIONAL, |

-- Need R

| | |
|---|---|
| gapSharing-r17 MeasGapSharingScheme | OPTIONAL, -- |

Need R

| | |
|---|---|
| gapPriority-r17 GapPriority-r17 | OPTIONAL, -- Need R |

[[
Ltm-CandidateId-r18 LTM-CandidateId-r18 OPTIONAL, -- Need R,
]]
}

In one embodiment, if the UE 100 is configured with the LTM measurement configuration and the UE 100 may require measurement gaps for at least one of the LTM measurement configurations and there is no measurement gap identifier associated with the LTM measurement configuration (no measurement gap id is provided as per one of the above embodiments), the UE 100 may use the measurement gap configured without measurement gap identifier (either per-UE gap or the per-FR gap applicable for the LTM measurement, i.e., the per-FR gap for the same FR as that of the frequency for LTM measurements) for the LTM measurements.

FIG. 7 illustrates a flow diagram of a method 700 for configuring the one or more measurement gaps based on UE capability information according to an embodiment as disclosed herein.

At step 701, the method 700 includes sending the UE capability enquiry message to the UE 100 of the wireless network. At step 702, the method 700 includes receiving, upon sending the UE capability enquiry message, UE capability information from the UE 100. At step 703, the method 700 includes determining whether the received UE capability information indicates the capability to perform one of the inter-frequency LTM measurements without the gap and intra-frequency LTM measurements without the gap. At step 704, the method 700 includes configuring, based on the determined capability, the one or more measurement gaps configuration to perform the one of inter-frequency LTM measurements without gap and the intra-frequency LTM measurements without gap, wherein the network device (e.g., gNB 200) send the one or more configured measurement gaps to the UE by utilizing a configuration message.

In one embodiment, the UE informs the network device 200 such as the gNB whether the UE 100 is capable of performing the inter-frequency LTM measurements without the gap. In one embodiment, the UE 100 may inform this capability as a per-UE capability. In one embodiment, if this information is indicated for FR1 and FR2 differently, each indication corresponds to the frequency range where the LTM measurements are performed. In an embodiment, the UE 100 may send the gNB 200 this information using existing RRC IE interFrequencyMeas-NoGap-r16. In this embodiment, the interFrequencyMeas-NoGap-r16 indicates if the UE 100 is capable of performing LTM measurements without the gap and whether the UE 100 may perform inter-frequency SSB-based measurements without measurement gaps if the SSB is completely contained in the active BWP of the UE 100 as specified in TS 38.133. In an embodiment, the UE 100 may send the gNB 200 this information using a new RRC IE (e.g., interFrequencyLTMMeas-NoGap-r18), and the new RRC IE indicates if the UE 100 is capable of performing LTM measurements without the gap. The network device 200 does not configure the measurement gap for inter-frequency LTM measurements if the network device 200 has received capability information that the UE 100 is capable of performing inter-frequency LTM measurements without the gap.

In an embodiment, if the network device 200 configures the UE 100 with dual connectivity, the network device 200 configures the UE 100 with measurement gaps for inter-frequency LTM measurements even if the UE 100 reports that the UE is capable of performing the inter-frequency LTM measurements without the gap.

In an embodiment, if the network device 200 configures the UE 100 with dual connectivity, the network device 200 configures the UE 100 with measurement gaps for inter-frequency LTM measurements configured by SN even if the UE 100 reports that the UE is capable of performing the inter-frequency LTM measurements without the gap.

In an embodiment, the UE 100 informs the network device 200 such as the gNB whether the UE 100 is capable of performing the inter-frequency LTM measurements without the gap in single connectivity. In an embodiment, this may be reported as a per-UE capability.

In an embodiment, the UE 100 informs the network device 200 such as the gNB whether the UE 100 is capable of performing the inter-frequency LTM measurements without the gap in dual connectivity (such as NR-DC, NR-NR DualConnecitivity). In an embodiment, this may be reported as a per-UE capability.

In an embodiment, the UE 100 informs the network device 200 such as the gNB whether the UE 100 is capable of performing the inter-frequency LTM measurements without the gap for measurements configured by MN (MCG) in dual connectivity (such as NR-DC, NR-NR DualConnecitivity). In an embodiment, this may be reported as a per-UE capability.

In an embodiment, the UE 100 informs the network device 200 such as the gNB whether the UE 100 is capable of performing the inter-frequency LTM measurements without the gap for measurements configured by SN (SCG) in dual connectivity (such as NR-DC, NR-NR DualConnecitivity). In an embodiment, this may be reported as a per-UE capability.

In an embodiment, the UE 100 informs the network device 200 such as the gNB whether the UE 100 is capable of performing the inter-frequency LTM measurements without the gap for measurements configured by MN (MCG) in dual connectivity (such as NR-DC, NR-NR DualConnecitivity) and also for the measurement configured by MCG in single connectivity. In an embodiment, this may be reported as a per-UE capability.

In one embodiment, the UE 100 informs the network device 200 such as the gNB whether the UE 100 is capable of performing the intra-frequency LTM measurements without the gap. In an embodiment, the UE 100 may inform this capability as a per-UE capability. In one embodiment, if this information is indicated for FR1 and FR2 differently, each indication corresponds to the frequency range where the LTM measurements are performed. In one embodiment, the UE 100 may send the gNB 200 this information using existing RRC IE. In one embodiment, the UE 100 may send the gNB 200 this information using a new RRC IE (e.g., intraFrequencyLTMMeas-NoGap-r18), and the new RRC IE indicates if the UE 100 is capable of performing LTM measurements without the gap. The network device 200 does not configure the measurement gap for intra-frequency LTM measurements if the network device 200 has received capability information that the UE 100 is capable of performing intra-frequency LTM measurements without the gap.

In an embodiment, if the network device 200 configures the UE 100 with dual connectivity, the network device 200 configures the UE 100 with measurement gaps for intra-frequency LTM measurements even if the UE 100 reports that the UE is capable of performing the intra-frequency LTM measurements without the gap.

In an embodiment, if the network device 200 configures the UE 100 with dual connectivity, the network device 200 configures the UE 100 with measurement gaps for intra-frequency LTM measurements configured by SN even if the UE 100 reports that the UE is capable of performing the intra-frequency LTM measurements without the gap.

In an embodiment, the UE 100 informs the network device 200 such as the gNB whether the UE 100 is capable of performing the intra-frequency LTM measurements without the gap in single connectivity. In an embodiment, this may be reported as a per-UE capability.

In an embodiment, the UE 100 informs the network device 200 such as the gNB whether the UE 100 is capable of performing the intra-frequency LTM measurements without the gap in dual connectivity (such as NR-DC, NR-NR DualConnectivity). In an embodiment, this may be reported as a per-UE capability.

In an embodiment, the UE 100 informs the network device 200 such as the gNB whether the UE 100 is capable of performing the intra-frequency LTM measurements without the gap for measurements configured by MN (MCG) in dual connectivity (such as NR-DC, NR-NR DualConnecitivity). In an embodiment, this may be reported as a per-UE capability.

In an embodiment, the UE 100 informs the network device 200 such as the gNB whether the UE 100 is capable of performing the intra-frequency LTM measurements without the gap for measurements configured by SN (SCG) in dual connectivity (such as NR-DC, NR-NR DualConnecitivity). In an embodiment, this may be reported as a per-UE capability.

In an embodiment, the UE 100 informs the network device 200 such as the gNB whether the UE 100 is capable of performing the intra-frequency LTM measurements without the gap for measurements configured by MN (MCG) in dual connectivity (such as NR-DC, NR-NR DualConnecitivity) and MCG. In an embodiment, this may be reported as a single-bit per-UE capability.

In one embodiment, the network device 200 may configure measurement gaps taking into account of the capabilities reported by the UE 100.

In one embodiment, the gNB 200 sends an RRC resume message with the LTM configuration including the measurement gap configuration to be used for the LTM and the UE 100 may apply the received LTM measurement gap configuration and send an RRC resume complete. All the embodiments of this disclosure that refer to the RRC reconfiguration and an RRC reconfiguration complete are equally applicable for an RRC Resume and an RRC resume complete respectively.

The various actions, acts, blocks, steps, or the like in the flow/sequence diagrams may be performed in the order presented, in a different order, or simultaneously. Further, in some embodiments, some of the actions, acts, blocks, steps, or the like may be omitted, added, modified, skipped, or the like without departing from the scope of the disclosure.

Unless otherwise defined, all technical and scientific terms used herein have the same meaning as commonly understood by one ordinary skilled in the art to which this disclosure belongs. The system, methods, and examples provided herein are illustrative only and not intended to be limiting.

While specific language has been used to describe the present subject matter, any limitations arising on account thereto, are not intended. As would be apparent to a person in the art, various working modifications may be made to the method to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) supporting a layer 1 (L1)/layer 2 (L2) triggered mobility (LTM) in a wireless communication system, the method comprising:
receiving, from a base station, a radio resource control (RRC) message including measurement gap configuration information and measurement reporting configuration information;
identifying a measurement gap for the LTM based on the measurement gap configuration information;
performing an L1 measurement on an inter-frequency within the measurement gap for the LTM; and
transmitting, to the base station, a measurement report associated with the L1 measurement based on the measurement reporting configuration information.

2. The method of claim 1, wherein the measurement gap configuration information is associated with a layer 3 (L3) measurement.

3. The method of claim 1, wherein the L1 measurement is performed based on a synchronization signal block (SSB).

4. The method of claim 1, wherein the RRC message further includes first information indicating a measurement gap sharing scheme applying to the measurement gap.

5. The method of claim 1, further comprising:
transmitting, to the base station, UE capability information for the L1 measurement on the inter-frequency associated with the measurement gap.

6. A method performed by a base station supporting a layer 1 (L1)/layer 2 (L2) triggered mobility (LTM) in a wireless communication system, the method comprising:
transmitting, to a user equipment (UE), a radio resource control (RRC) message including measurement gap configuration information and measurement reporting configuration information; and
receiving, from the UE, a measurement report associated with an L1 measurement,
wherein a measurement gap for the LTM is based on the measurement gap configuration information, and
wherein the L1 measurement on an inter-frequency is performed within the measurement gap for the LTM.

7. The method of claim 6, wherein the measurement gap configuration information is associated with a layer 3 (L3) measurement.

8. The method of claim 6, wherein the L1 measurement is performed based on a synchronization signal block (SSB).

9. The method of claim 6, wherein the RRC message further includes first information indicating a measurement gap sharing scheme applying to the measurement gap.

10. The method of claim 6, further comprising:
receiving, from the UE, UE capability information for the L1 measurement on the inter-frequency associated with the measurement gap.

11. A user equipment (UE) supporting a layer 1 (L1)/layer 2 (L2) triggered mobility (LTM) in a wireless communication system, the UE comprising:
a transceiver; and
a controller configured to:
receive, from a base station, a radio resource control (RRC) message including measurement gap configuration information and measurement reporting configuration information,
identify a measurement gap for the LTM based on the measurement gap configuration information,
perform an L1 measurement on an inter-frequency within the measurement gap for the LTM, and
transmit, to base station, a measurement report associated with the L1 measurement based on the measurement reporting configuration information.

12. The UE of claim 11, wherein the measurement gap configuration information is associated with a layer 3 (L3) measurement.

13. The UE of claim 11, wherein the L1 measurement is performed based on a synchronization signal block (SSB).

14. The UE of claim 11, wherein the RRC message further includes first information indicating a measurement gap sharing scheme applying to the measurement gap.

15. The UE of claim 11, wherein the controller is further configured to:
transmit, to the base station, UE capability information for the L1 measurement on the inter-frequency associated with the measurement gap.

16. A base station supporting a layer 1 (L1)/layer 2 (L2) triggered mobility (LTM) in a wireless communication system, the base station comprising:
a transceiver; and
a controller configured to:
transmit, to a user equipment (UE), a radio resource control (RRC) message including measurement gap configuration information and measurement reporting configuration information, and
receive, from the UE, a measurement report associated with an L1 measurement,
wherein a measurement gap for the LTM is based on the measurement gap configuration information, and
wherein the L1 measurement on an inter-frequency is performed within the measurement gap for the LTM.

17. The base station of claim 16, wherein the measurement gap configuration information is associated with a layer 3 (L3) measurement.

18. The base station of claim 16, wherein the L1 measurement is performed based on a synchronization signal block (SSB).

19. The base station of claim 16, wherein the RRC message further includes first information indicating a measurement gap sharing scheme applying to the measurement gap.

20. The base station of claim 16, wherein the controller is further configured to:
receive, from the UE, UE capability information for the L1 measurement on the inter-frequency associated with the measurement gap.
